(19) United States
(12) Patent Application Publication
(10) Pub. No.: US 2008/0025037 A1
(43) Pub. Date: Jan. 31, 2008

(54) LED headlamp

(75) Inventors: Jeyachandrabose Chinniah, Canton, MI (US); Amir P. Fallahi, West Bloomfield, MI (US); Thomas L. Jones, Huntsville, AL (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/495,364

(22) Filed: Jul. 28, 2006

(51) Int. Cl. F21S 8/10

(52) U.S. Cl. 362/545; 362/543

(57) ABSTRACT

A lamp assembly is disclosed and includes a light source and a lens. The lens is configured to receive light from the light source and to project a predetermined beam pattern. The light source includes at least one LED chip and has a light-emitting surface that is defined by the at least one chip. The light-emitting surface is shaped to correspond with the predetermined beam pattern. Additional aspects of the invention include a LED light source for a lamp.

### FIELD OF THE INVENTION

The present invention relates generally to vehicle exterior lighting, and in particular to vehicle headlamps that include a LED light source.

### BACKGROUND OF THE INVENTION

One of the challenges in vehicle exterior lighting design, for example headlamp design, is creating a desired beam pattern. This is particularly true in motor vehicle applications, where government standards mandate complex asymmetric beam patterns. A conventional vehicle headlamp includes a light source and optical components, such as lenses, reflectors, and shields, to collect and shape light emitted by the light source and to project the resulting beam pattern forward of the vehicle.

Light sources that are suitable for exterior lighting applications include incandescent, halogen, and HID bulbs. In recent years, light emitting diodes (LEDs) have become a popular light source for automotive exterior lighting applications. Generally, conventional light sources emit light images that have a different shape and/or light intensity profile than that of the predetermined beam pattern. For example, LED light sources have been provided that emit a uniform-intensity beam of light from a generally square or rectangular LED surface, and therefore emit a generally square or rectangular light image.

To provide the predetermined beam pattern, conventional light sources are paired with one or more reflectors and lenses to reshape the projected light image. Additionally, a shield may be provided to block a portion of the light and thereby create a light cut-off. Such optics are mechanically complex, challenging to design and manufacture, and add cost to the headlamp.

In view of the foregoing, there exists a need to provide a vehicle exterior lighting device that is capable of producing a desired beam pattern and that minimizes the use of complex and costly optics.

### BRIEF SUMMARY OF THE INVENTION

According to an aspect of the invention, a lamp assembly, for example, a headlamp assembly is provided and comprises a light source and a lens. The light source includes at least one LED chip and has a light-emitting surface that is defined by the at least one LED chip. The light-emitting surface is configured to project a predefined light image therefrom with a shape that corresponds with the surface, which is shaped to correspond with a predetermined beam pattern. The lens is configured to receive the light image and to project the predetermined beam pattern and may be a condenser lens. The light source may be disposed generally at a focal point of the lens. Accordingly, the predetermined beam pattern is provided simply by projecting the light that is emitted from the light source, without the need for complex reflectors and shields to shape and form the beam pattern.

The light source may comprise at least two LED chips that define the light-emitting surface of the light source. The light-emitting surface is shaped to correspond with and to provide the predetermined beam pattern. To provide a relatively smooth and continuous light emitting surface, and therefore a relatively smooth and continuous beam pattern, the LED chips may be arranged in near-contiguous relationship to one another. This is in sharp contrast conventional LED lamp systems in which LED chips are spaced apart by a distance that greatly exceeds the lateral dimension of the individual chips. Such systems rely on dedicated optics, including reflectors and lenses, to reshape and to project each chip image to provide a satisfactory composite beam pattern. The chips may have a chip spacing that is less than 0.2 mm. Preferably, the chip spacing will be less than 0.1 mm.

The at least two chips may be selected from a variety of chip shapes. For example, the chips may have a generally square, or rectangular shape. The chips may have any other suitable shape, including, but not limited to, triangular, trapezoidal, and hexagonal.

According to another aspect of the invention, a lamp may be provided and have a light source that includes at least two LED chips, as described above, with one of the at least two chips configured to emit light at a first intensity, and another of the at least two LED chips configured to emit light at a second intensity that is greater than the first intensity. This aspect of the invention is particularly useful for creating variable-intensity beam patterns, for example automotive low-beam and automotive high-beam patterns.

According to another aspect of the invention, a lamp may be provided and may have a first light source for providing a first predetermined beam pattern, as described above. The lamp may further comprise at least a second light source for providing a second predetermined beam pattern. The second light source includes at least one LED chip and has a second light-emitting surface defined by the at least one chip. The second light-emitting surface is configured to project a second light image therefrom and is shaped to correspond with the second predetermined beam pattern. The first light source may be independently operable with respect to the second light source. The second light-emitting surface may comprise the first light-emitting surface.

According to another aspect of the invention, a LED light source may be provided for a lamp configured to project a predetermined beam pattern. The light source comprises at least two LED chips and has a light-emitting surface defined by at least two chips. The LED chips are disposed in a near-contiguous relationship with respect to one another. The light-emitting surface is shaped to correspond with the predetermined beam pattern. In a preferred embodiment, the chips have a chip spacing that is less than 0.2 mm with a chip spacing of less than 0.1 mm being more preferred.

The chips may include a variety of shapes, as described above, including, but not limited to generally triangular, hexagonal, and trapezoidal. One of the at least two chips may be configured to emit light at an intensity that is higher than the intensity of another of the at least two chips. The at least one chip may be shaped to provide any suitable beam pattern including, but not limited to, an automotive low-beam pattern and an automotive high-beam pattern.

### BRIEF DESCRIPTION OF THE DRAWINGS

FIG. 1A shows a partial cross-sectional view of a lamp according to an aspect of the present invention;

FIG. 1B illustrates a light image emitted by the surface of the light source of FIG. 1A;

FIG. 1C illustrates a beam pattern projected by the lens of the lamp of FIG. 1A;

FIG. 2A is a partial cross-sectional view of a lamp according to an aspect of the present invention;

FIG. 2B illustrates a beam pattern that may be projected by the lamp of FIG. 2A;

FIGS. 3A and 3B show perspective views of various LED light sources;

FIG. 4A is a schematic of a LED light source according to an aspect of the present invention;

FIG. 4B is a perspective view of a portion of the LED light source of FIG. 4A;

FIG. 5 is a schematic of a LED light source according to an aspect of the present invention;

FIG. 6 illustrates a beam pattern that may be produced using the LED light source shown in FIG. 5;

FIGS. 7A and 7B illustrate various LED chip shapes that may be used in the present invention;

FIG. 7C is a schematic of a LED light source according to an aspect of the present invention;

FIGS. 8 and 9A are schematics of various LED light sources according to aspects of the invention;

FIG. 9B illustrates a beam pattern that may be produced using the LED light source shown in FIG. 9A; and

FIG. 10 is a side perspective view of a lamp according to another aspect of the invention.

### DETAILED DESCRIPTION OF THE INVENTION

The present invention relates generally to vehicle exterior lighting devices, for example, headlamps, fog lamps and signal lamps. Indications will be given throughout the specification to preferred and alternative embodiments of the invention, including the application of various aspects of the invention to vehicle headlamps. It should be understood that the following detailed description is illustrative, rather than limiting, and that the invention is not limited to headlamp applications, but rather includes other vehicle exterior lighting applications.

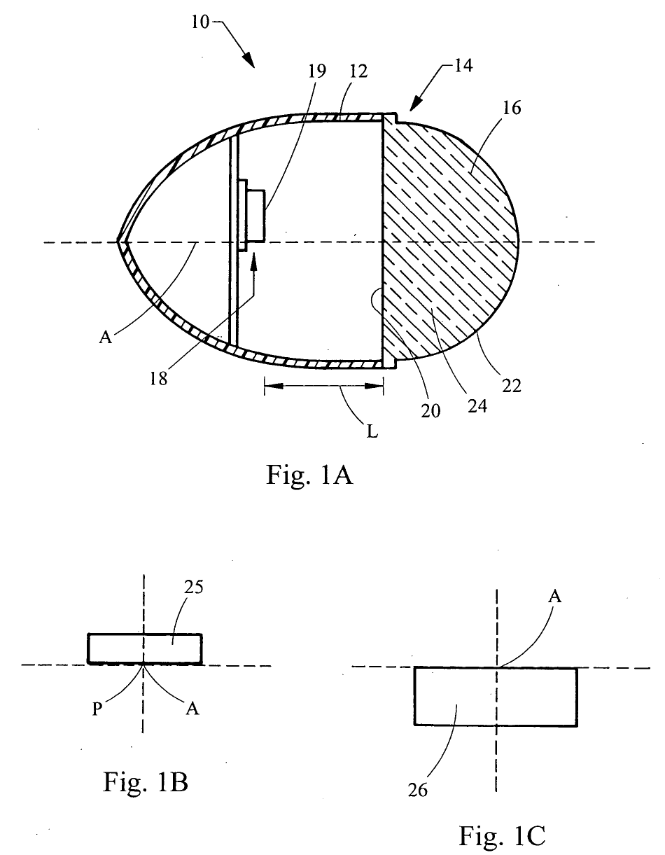

FIG. 1A illustrates a headlamp 10 according to an aspect of the present invention. The headlamp 10 includes a housing 12 having a front opening 14, and a lens 16 attached to the housing 12 that covers the front opening 14. The housing 12 may be square, rectangular, oval, round, oblong, or any other suitable shape. Housing 12 may be formed of any suitable material including, but not limited to, plastic, fiberglass, metal, or combinations thereof.

The lens 16 is capable of receiving and projecting light from a light source 18 that is located within the housing 12. Lens 16 has a first surface 20, and a second surface 22 defined by a body portion 24 therebetween. The first surface 20 is generally planar and is positioned generally perpendicular to the optical axis A. In the embodiment shown in FIG. 1A, the second surface 22 has a generally convex curvature with a contour that may be obtained by a surface revolution of a two-dimensional curve about the optical axis A.

Lens 16 is an imaging optic which projects a light image 25 (shown in FIG. 1B) that is placed at its focal point, or within its focal plane, forward of the headlamp. The lens 16 is preferably a condenser lens and may be an axisymmetric aspheric lens. The lens is positioned so that the first surface 20 faces and covers the front opening 14 of the housing 12. As such, the first surface 20 receives light from the light source 18, transmits the light through the body portion 24, and projects it through the second surface 22. The lens 16 projects a beam pattern 26 having a shape that is generally the same as the image 25, but that is horizontally and vertically inverted with respect to the optical axis A, as shown in FIG. 1C.

In one embodiment of the invention, the light source 18 is a LED light source and comprises at least one LED. Power for the light source 18 may be provided by a low voltage power supply or 12 volt power supply which is conventionally available in vehicles. Light source 18 may be in electrical communication with a control module, such as a circuit board, or other memory device integrated with the headlamp 10 or separate from the headlamp. Alternatively, the control module may be integrated with other vehicle electronics, dedicated to light source 18. The headlamp 10 further comprises a thermal management device (not shown), for managing heat that is generated by the light source 18. Suitable heat management devices include, for example, heat sinks that can be in the form of heat dissipating fins in thermal communication with the light source 18, or cooling fans that can be activated when the lamp temperature exceeds a predetermined limit.

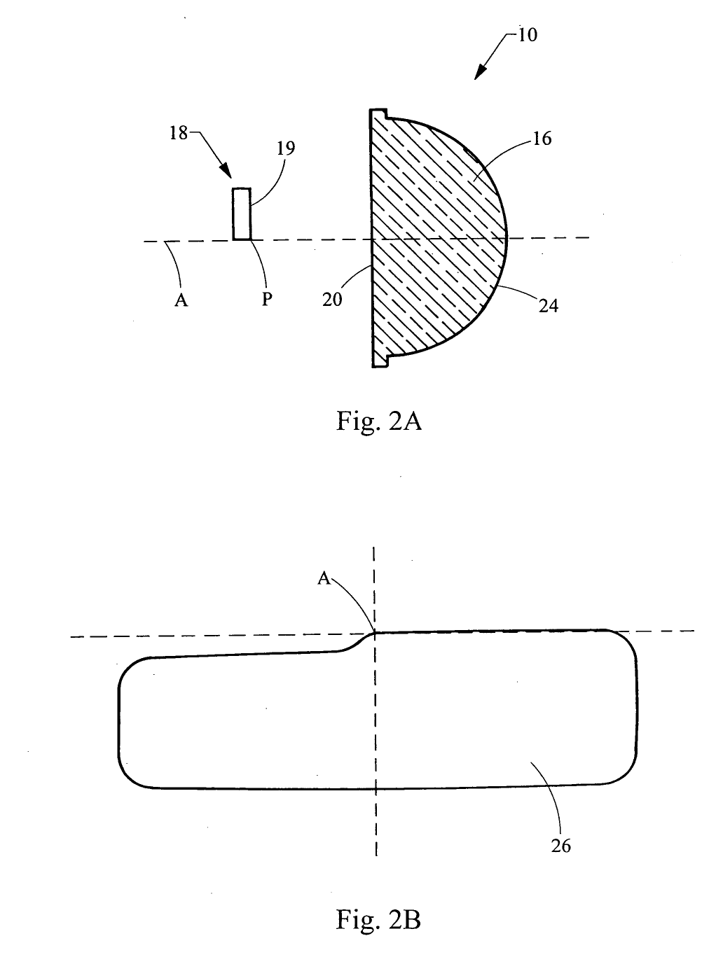

The light source 18 is configured to emit light over a surface 19 that is defined by the at least one LED. The light-emitting surface 19 emits a light image that has a shape corresponding with the shape of the surface 19. The surface 19 may have a generally planar contour. Alternately, the surface 19 may have a concave or convex contour. In the embodiment shown in FIG. 2A, the light source 18 is positioned so that the light-emitting surface 19 is generally perpendicular to the optical axis and faces the first surface 20 of the lens 16. Additionally, the light source 18 is positioned so that the light-emitting surface 19 corresponds generally with the focal point P of the lens 16. The lens 16, accordingly, will receive the light image 25 that is generated at the surface 19 of the light source 18. If, as in conventional light sources, the light-emitting surface 19 is generally square or rectangular, the lens 16 will project a generally square or rectangular beam pattern 26.

According to an aspect of the invention, the light source 18 may have a light-emitting surface 19 that is shaped to correspond with the predetermined beam pattern 26. For example, the light source 18 in FIG. 2A may have a light-emitting surface 19 that is shaped to correspond with an automotive low-beam pattern. An automotive low-beam pattern generally has an oblong asymmetric shape with a horizontal dimension larger than a vertical dimension. The beam pattern 26 may have a horizontal cutoff portion having a generally stepped contour. By using a light source with a shaped light-emitting surface 19 as described, the headlamp 10 will produce a low-beam pattern 26, as shown in FIG. 2B.

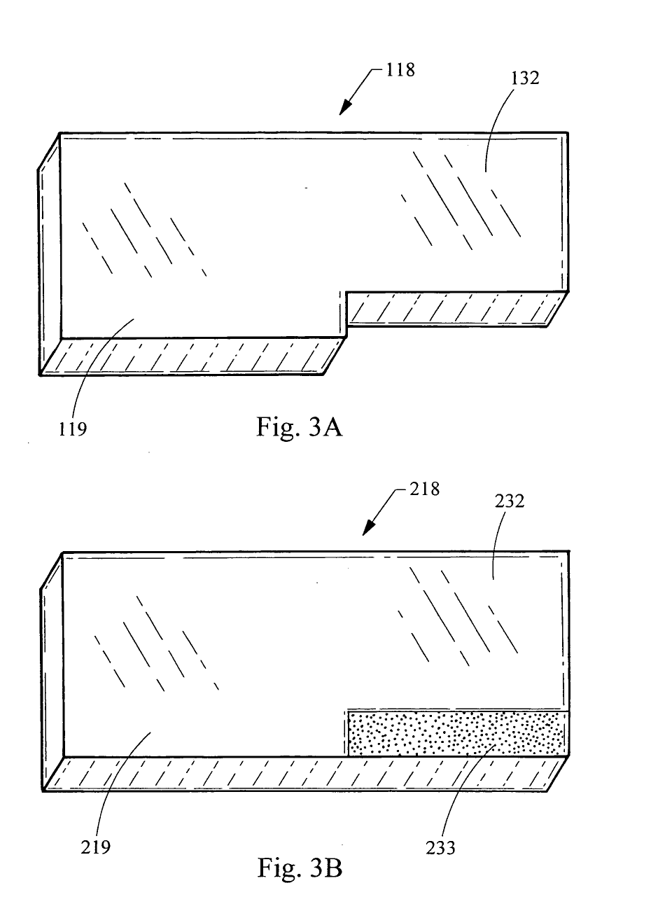

FIG. 3A illustrates a LED light source 118, according to an aspect of the invention. The light source 118 includes a light-emitting surface 119 having a stepped shape. The light-emitting surface is defined by one or more LED chips 132 that are arranged and shaped in a stepped form.

FIG. 3B illustrates another LED light source 218 including a light-emitting surface 19 having a stepped shape. The light source 218 comprises one or more LED chips 232 that are arranged and shaped in a generally rectangular form. In this embodiment, an opaque mask 233 covers or obscures a portion of the light source 218, thereby providing a stepped light-emitting surface 219. The mask may include an opaque coating or surface treatment.

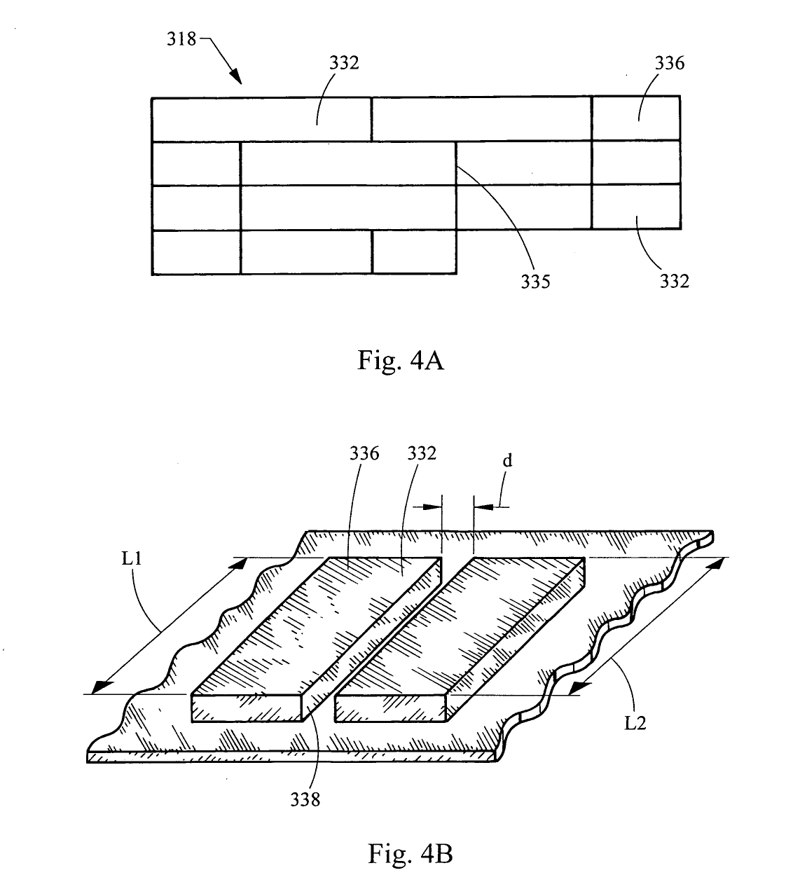

In FIG. 4A, a light source 318 is provided that includes a plurality of LED chips 332, each having a light-emitting surface 336. The chips 332 are arranged in a side-by-side manner so that the light-emitting surfaces 336 all face in generally the same direction and form the light-emitting surface 319 of the light source 318. The inventors have discovered that if the LED chips 332 are spaced too far apart from one another, the corresponding beam pattern will be broken, irregular, or discontinuous. Such a “digitized” beam pattern is highly undesireable for headlamp applications.

Accordingly, adjacent chips 332 should be placed in relatively close proximity. Adjacent chips 332 are preferably placed in near-contiguous relationship with respect to one another so that the chips are in contact or are substantially in contact. Adjacent chips 332 are spaced apart from one another by a chip spacing 335 that is generally defined by the distance d between lateral edges 338 of the chips 332, as shown in the enlarged view in FIG. 4B. The chip spacing 335 between adjacent chips 332 is preferably small in comparison with the lengths L1, L2 of the adjacent lateral edges 338. LED chips 32 are currently commercially available in a variety of generally square or rectangular shapes and sizes, for example from 1 mm×1 mm to 1 mm×10 mm. LED chips 32 that are suitable for use with the present invention are available from Philips Lumileds Lighting Company and from Osram Sylvania. To avoid a “digitized” beam pattern, the chip spacing 335 between adjacent chips 332 may be less than 0.2 mm or may be less than 0.15 mm. In a preferred embodiment, the chip spacing is less than 0.1 mm.

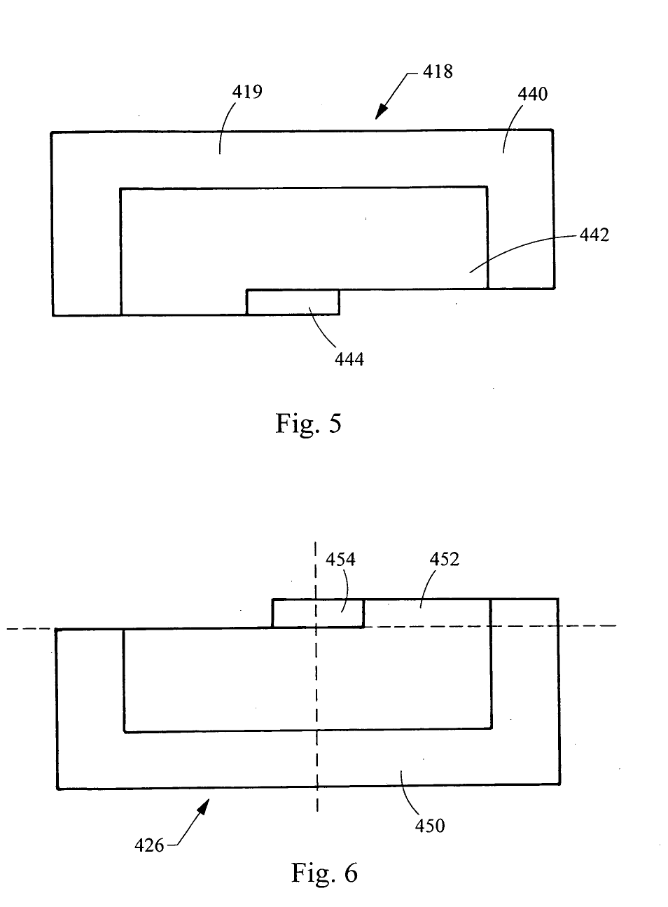

FIG. 5 shows a LED light source 418, according to another embodiment of the invention. The light source 418 comprises a first light-emitting portion 440, a second light-emitting portion 442, and a third light-emitting portion 444. Each of the portions 440, 442, 444 comprises one or more LED chips 432, as described above. The portions 440, 442, 444 are arranged to form a light-emitting surface 419 having a shape that corresponds with a predetermined beam pattern 426. According to an aspect of the invention, each of the portions 440, 442, 444 has a distinct output characteristic. For example, each of the portions 440, 442, 444 may be configured to emit light at different frequencies or colors. Alternately, or additionally, each of the portions 440, 442, 444 may be configured to emit light at different intensities or levels of brightness.

In an exemplary embodiment, the first portion 440 comprises one or more LED chips 432 having a relatively low output, the third portion 444 comprises one or more LED chips 432 having a relatively high output, and the second portion 442 comprises one or more LED chips 432 having an output that is intermediate the output of the first and third portions. For example, in a preferred embodiment, the first portion 440 may comprise one or more chips 432 having an output of 25 or 50 lumens, the second portion 442 may comprise one or more chips 432 having an output of 100 lumens, and the third portion 444 may comprise one or more chips 432 having an output of 200 lumens. One of ordinary skill in the art will appreciate that the number, size, shape, and other characteristics of the light-emitting portions may be varied within the scope and spirit of the present invention.

FIG. 6 illustrates the beam pattern 426 that may be produced using the light source 418 shown in FIG. 5. The beam pattern 426 has a shape that corresponds generally with the shape of the light emission surface 419, but is horizontally and vertically inverted with respect to the optical axis A. The beam pattern 426 comprises a low light-intensity portion 450, an intermediate light-intensity portion 452, and a high light-intensity portion 454. Each of the beam pattern portions 450, 452, 454 has a shape and an intensity that corresponds with the shape and intensity of the corresponding LED construction portion 440, 442, 444.

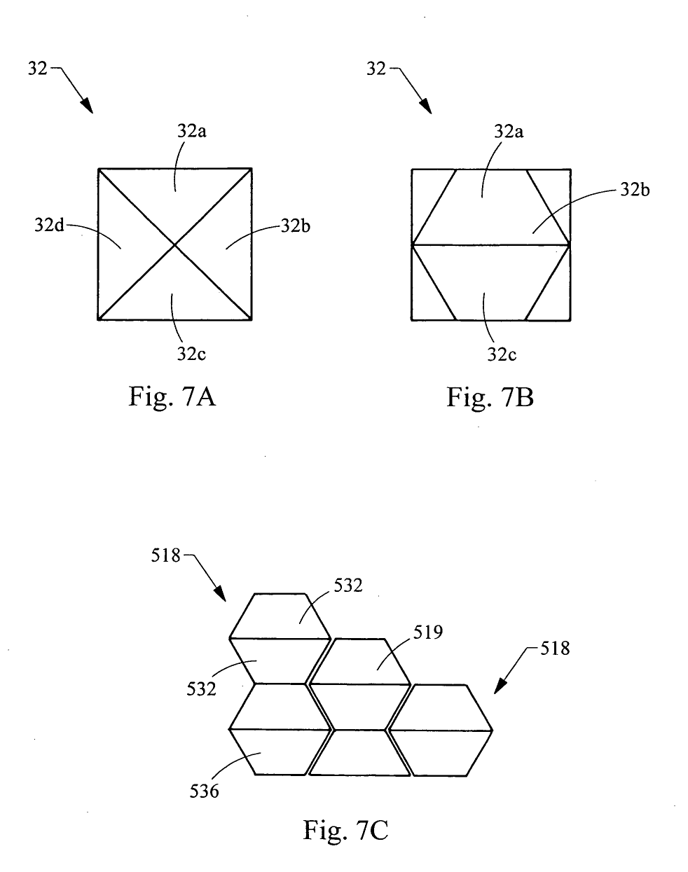

The LED light source 18 may be formed using LED chips 32 of various shapes and sizes. In addition to conventional LED chip shapes, such as rectangles and squares, a light source 18 may comprise chips 32 having other geometric forms, including generally triangular, trapezoidal, and hexagonal forms. These and other suitable shapes are contemplated and may have straight and/or curved edges. Suitable chip forms may be produced directly in the desired shape. Alternately, suitable forms may be cut from larger chips. For example, LED chip shapes may be formed from a generally square LED chip, as shown in FIGS. 7A and 7B. In FIG. 7A, four triangular chips 32a, 32b, 32c, 32d are formed from a single square chip 32. In FIG. 7B, one hexagonal chip 32a, or two trapezoidal chips 32b, 32c may be formed from a single square chip 32. FIG. 7C illustrates an LED light source 518 comprising a plurality of trapezoidal LED chips 532. The chips 532 are arranged to form a light-emission surface 519 having a shape corresponding with a predetermined beam pattern.

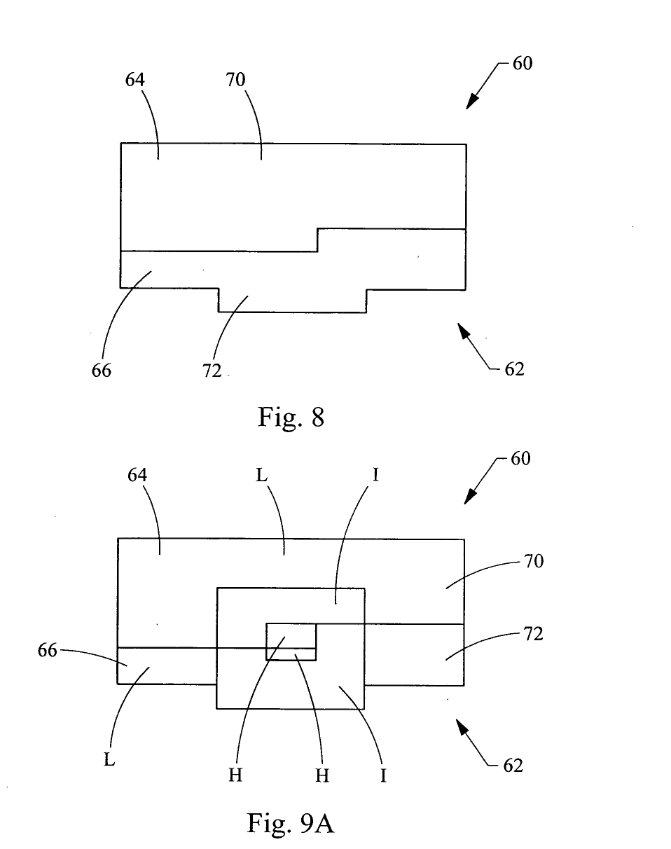

According to another aspect of the invention, two or more independently operable LED light sources 60, 62 may be combined in a single headlamp module to provide multiple beam patterns. In the embodiment shown in FIG. 8, a construction is provided that includes a first light source 60 and a second light source 62. Each of the light sources 60, 62 comprises one or more LED chips 70, 72, as described above. The first light source 60 is configured to emit light over a surface 64 that is defined by the one or more first LED chips 70. Similarly, the second light source 62 is configured to emit light over a surface 66 that is defined by the one or more second LED chips 72. The first and second light sources 60, 62 may be positioned in a headlamp 10 so that the light emission surfaces 64, 66 are generally perpendicular to the optical axis and correspond with the focal point P of the lens 16.

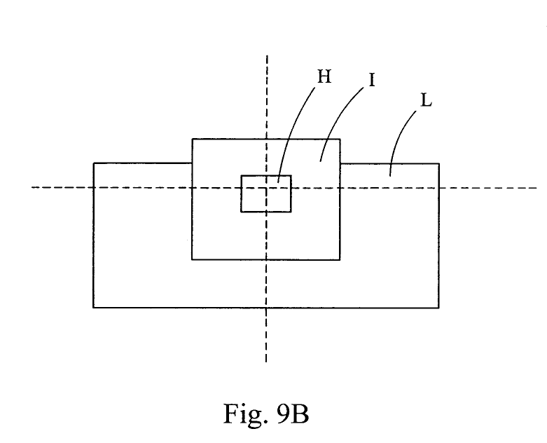

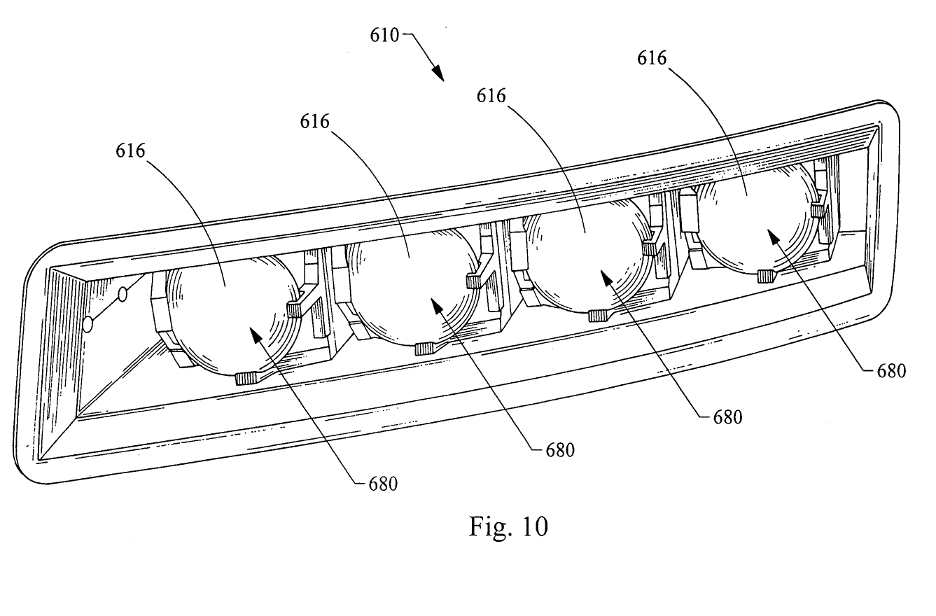

In the embodiment shown in FIG. 9A, a first light source 60 is provided for an automotive low-beam function and a second light source 62 is provided for an automotive high-beam function. It will be immediately apparent that in the embodiment of FIG. 9A, the second light emission surface 66 comprises the first light emission surface 64. In other words, the first light source is operable in both the low-beam function and the high-beam function. The first and second light sources 60, 62 each comprise a plurality of LED chips 70, 72 having a variety of light outputs. Each light source 60, 62 comprises a low-intensity portion L, an intermediate-intensity portion 1, and a high-intensity portion H, as described above. FIG. 9B illustrates a variable-intensity beam pattern that corresponds with the second light source 62 shown in FIG. 9A. Other automotive applications for various aspects of the present invention are contemplated and are within the scope of the present invention.

FIG. 10 illustrates another embodiment of the present invention. A lamp 610 is provided and comprises a plurality of lamp modules 680. In the embodiment shown in FIG. 10, the lamp 610 includes four modules 680. The modules 680 may be arranged linearly, for example in a horizontal or vertical configuration, or may be arranged in various other desirable geometric orientations, shapes, or configurations. It will be apparent that a greater or a fewer number of modules 680 may be provided in accordance with the present invention.

Each of the modules 680 is provided in accordance with various aspects of the invention, as described throughout the specification. For example, each of the modules 680 comprises a light source 618, and a lens 616 that is configured to receive and project light from the light source 618. Each light source 618 may be a LED light source as described above. Each of the light sources 618 has a light-emitting surface (not shown) that is shaped to correspond with a predetermined beam pattern.

In one embodiment, the lamp 610 comprises a plurality of modules 680, with each module being configured to provide a separate and distinct beam pattern. For example, the lamp 610 may comprise at least one module corresponding with a low-beam pattern and at least one module corresponding with a high-beam pattern. The low-beam module will have a light source with a light-emitting surface that is shaped to correspond with a low-beam pattern and the high-beam module will have a light source with a light-emitting surface that is shaped to correspond with a high-beam pattern. Additionally, or alternatively, the lamp 610 could comprise separate modules corresponding with other exterior lighting applications, including signals, and fog lamps. Each of the modules will have a light source with a light-emitting surface that is shaped to correspond with the appropriate beam-pattern for the particular application. In use, the modules are selectively operated to provide the desired beam pattern.

In another embodiment, the lamp 610 comprises a plurality of modules 680, with each module being configured to provide generally the same beam pattern. For example, the light sources in each of the modules may have generally identically-shaped light-emitting surfaces, each corresponding with the low-beam pattern. In this embodiment, the modules are operated in unison so that the beams projected by the modules 680 coalesce forward of the lamp to provide a single composite beam pattern. The modules 680 are preferably disposed in close proximity with one another and are arranged so that the shape of the composite beam pattern corresponds generally with the shape of each of the individual light-emitting surfaces. For example, the individual modules may preferably have a spacing that is less than 20 mm, or less than 10 mm, and more preferably as small as manufacturing tolerances will allow. The individual beams will overlap slightly in the composite beam pattern, minimizing any digitization that might result from LED chip spacing.

Throughout this specification various indications have been given as to preferred and alternative embodiments of the invention. However, it should be understood that the invention is not limited to any one of these. It is therefore intended that the foregoing detailed description be regarded as illustrative rather than limiting, and that it be understood that it is the appended claims, including all equivalents, that are intended to define the spirit and scope of this invention.

1. A lamp assembly comprising:
a light source including at least one LED chip and having a light-emitting surface defined by the at least one LED chip, wherein the light-emitting surface is configured to project a predefined light image therefrom; and
a lens configured to receive the light image and to project a predetermined beam pattern, wherein the light-emitting surface is shaped to correspond with the beam pattern.

2. The lamp assembly according to claim 1, wherein the beam pattern is an automotive low-beam pattern.

3. The lamp assembly according to claim 1, wherein the beam pattern is an automotive high-beam pattern.

4. The lamp assembly according to claim 1, wherein the light source includes at least two LED chips, the light-emitting surface being defined by the at least two LED chips.

5. The lamp according to claim 4, wherein the at least two LED chips are spaced in near-contiguous relationship to one another.

6. The lamp according to claim 4, wherein the at least two LED chips have a chip spacing that is less than 0.2 mm.

7. The lamp according to claim 4, wherein the at least two LED chips have a chip spacing that is less than 0.1 mm.

8. The lamp according to claim 4, wherein one of the at least two LED chips is configured to emit light at a first intensity, and another of the at least two LED chips is configured to emit light at a second intensity that is greater than the first intensity.

9. The lamp according to claim 1, further comprising a second light source including at least one LED chip and having a second light-emitting surface defined by the at least one LED chip, wherein the second light emitting surface is configured to project a second light image therefrom, and wherein the second light-emitting surface is shaped to correspond with a second predetermined beam pattern.

10. The lamp according to claim 9, wherein the first light source is independently operable with respect to the second light source.

11. The lamp according to claim 9, wherein the second light-emitting surface comprises at least a portion of the first light-emitting surface.

12. The lamp according to claim 9, wherein the first light source corresponds with an automotive low-beam pattern and the second light source corresponds with an automotive high-beam pattern.

13. The lamp according to claim 1, wherein the at least one LED chip has a shape selected from generally triangular, trapezoidal, and hexagonal.

14. The lamp according to claim 1, wherein the lens is a condenser lens.

15. The lamp according to claim 1, wherein the light source is disposed generally at a focal point of the lens.

16. The lamp according to claim 1, further comprising:
a second light source including at least one LED chip and having a second light-emitting surface defined by the at least one LED chip, the second light-emitting surface being configured to project a second light image therefrom, and the second light-emitting surface being shaped to correspond with a second predetermined beam pattern, wherein the first light source is independently operable with respect to the second light source, wherein, the second light-emitting surface comprises at least a portion of the first light-emitting surface, and wherein the first light source corresponds with an automotive low-beam pattern and the second light source corresponds with an automotive high-beam pattern;
wherein at least one of the first and second light sources includes at least two LED chips, the corresponding light-emitting surface being defined by the at least two LED chips, the LED chips having a chip spacing that is one of less than 0.2 mm and less than 0.1 mm, wherein one of the at least two LED chips is configured to emit light at a first intensity, and another of the at least two LED chips is configured to emit light at a second intensity that is greater than the first intensity, and wherein at least one of the LED chips has a shape selected from triangular, trapezoidal, and hexagonal;
wherein the lens is a condenser lens; and
wherein the first and second light images are emitted generally at a focal point of the lens.

17. A LED light source for a lamp having a predetermined beam pattern, the light source comprising at least two LED chips disposed in a near-contiguous relationship with respect to one another, the light source having a light-emitting surface defined by the at least two LED chips, wherein the light-emitting surface is shaped to correspond with the predetermined beam pattern.

18. The light source according to claim 17, wherein the at least two chips have a chip spacing of less than 0.2 mm.

19. The light source according to claim 17, wherein the at least two chips have a chip spacing of less than 0.1 mm.

20. The light source according to claim 17, wherein one of the at least two LED chips is configured to emit light at a first light intensity and another of the at least two LED chips is configured to emit light at a second light intensity that is greater than the first intensity.
